(19) United States
(12) Patent Application Publication
(10) Pub. No.: US 2017/0066352 A1
(43) Pub. Date: Mar. 9, 2017

(54) VEHICLE SEAT

(71) Applicant: TOYOTA BOSHOKU KABUSHIKI KAISHA, Aichi-ken (JP)

(72) Inventor: Hiroyuki NASU, Aichi-ken (JP)

(73) Assignee: TOYOTA BOSHOKU KABUSHIKI KAISHA, Aichi-ken (JP)

(21) Appl. No.: 15/252,778

(22) Filed: Aug. 31, 2016

(30) Foreign Application Priority Data
Sep. 7, 2015 (JP) 2015-175483

(51) Int. Cl. B60N 2/48; B60N 2/64

(52) U.S. Cl. CPC B60N 2/4808; B60N 2/64; B60N 2002/4894; B60N 2002/4897

(57) ABSTRACT

A vehicle seat includes a seatback; a headrest that has a stay; and a headrest support that is arranged on an upper portion of the seatback so as to extend in a vertical direction, and that supports the stay in a manner that allows the stay to move in the vertical direction with an outer surface of the stay in sliding contact with a surface of an inner cylinder portion of the headrest support. The surface of the inner cylinder portion is covered by a resin coating that has a lower coefficient of friction with respect to the outer surface of the stay than material of which the headrest support is made.

### INCORPORATION BY REFERENCE

The disclosure of Japanese Patent Application No. 2015-175483 filed on Sep. 7, 2015 including the specification, drawings and abstract is incorporated herein by reference in its entirety.

### BACKGROUND OF THE INVENTION

1. Field of the Invention

The invention relates to a vehicle seat.

2. Description of Related Art

A vehicle seat is known in which a stay of a headrest is attached to a vertically extending cylindrical headrest support arranged on an upper portion of a seatback, in a manner able to move in the vertical direction with an outer surface of the stay in sliding contact with a surface of an inner cylinder portion of the headrest support. In an invention described in Japanese Patent Application Publication No. 2005-287738 (JP 2005-287738 A), the outer surface of the stay is covered with a polytetrafluoroethylene (hereinafter, referred to as “PTFE”) resin coating in order to make the operational feeling when moving the stay in the vertical direction lighter.

### SUMMARY OF THE INVENTION

When moving a stay upward with respect to a headrest support, a portion of the stay is exposed outside a vehicle seat. With the invention described in JP 2005-287738 A, if a hard object made of metal or the like strikes the exposed portion, the PTFE resin coating that covers the portion that was struck may be scraped, and the outer surface of the stay may appear damaged. As a result, the appearance of the vehicle seat may be damaged.

To solve this kind of problem, the invention provides a vehicle seat capable of making the operational feeling when moving the stay in the vertical direction with respect to the headrest support lighter, as well as inhibiting the appearance from being damaged.

One aspect of the invention relates to a vehicle seat that includes a seatback; a headrest that has a stay; and a headrest support that is arranged on an upper portion of the seatback so as to extend in a vertical direction, and that supports the stay in a manner that allows the stay to move in the vertical direction with an outer surface of the stay in sliding contact with a surface of an inner cylinder portion of the headrest support. The surface of the inner cylinder portion is covered by a resin coating that has a lower coefficient of friction with respect to the outer surface of the stay than material of which the headrest support is made.

According to this broadest aspect, the surface of the inner cylinder portion of the headrest support is covered by a resin coating that has a lower coefficient of friction with respect to the outer surface of the stay than the material of which the headrest support is made. Therefore, when the stay is moved in the vertical direction with respect to the headrest support, sliding resistance generated between the surface of the inner cylinder portion of the headrest support and the outer surface of the stay is reduced, which makes the operational feeling lighter. Also, the resin coating described above covers the surface of the inner cylinder portion of the headrest support, so even if the stay is moved upward with respect to the headrest support, the resin coating will not be exposed outside the vehicle seat. Therefore, the resin coating will not easily be scraped, and even if it does get scraped, the scraped portion will not appear outside the vehicle seat, so the appearance of the vehicle seat is able to be inhibited from being damaged.

In the aspect described above, the headrest support may be fixed to the seatback by being fitted into the inner cylinder portion of a vertically extending cylindrical support bracket that is attached to a back frame of the seatback, and a surface of an outer cylinder portion of the headrest support may be covered by the resin coating.

According to this aspect, when the headrest support is fitted into the inner cylinder portion of the support bracket, sliding resistance generated between the surface of the outer cylinder portion of the headrest support and the surface of the inner cylinder portion of the support bracket is able to be reduced. Therefore, workability with respect to the assembly work of the headrest support is able to be improved.

In the aspect described above, the stay may be configured such that movement thereof in the vertical direction is restricted when an engaging portion provided in a manner able to move in and out on an upper end portion of the inner cylinder portion of the headrest support engages with an adjusting groove formed on the stay, and movement thereof in the vertical direction is allowed when the engaging portion disengages from the adjusting groove. Also, a surface of the upper end portion of the inner cylinder portion of the headrest support may not be covered by the resin coating.

With this structure, in addition to making the operational feeling when moving the stay in the vertical direction with respect to the headrest support lighter, and inhibiting the appearance from being damaged, the resin coating will not easily be affected by the in and out movement of the engaging portion.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a vehicle seat according to one example embodiment of the invention;

FIG. 2 is an exploded perspective view of a headrest, a headrest support, and a back frame that have been disassembled;

FIG. 3 is a perspective view of the headrest support according to the example embodiment; and

FIG. 4 is a sectional view taken along line IV-IV in FIG. 1.

### DETAILED DESCRIPTION OF EMBODIMENTS

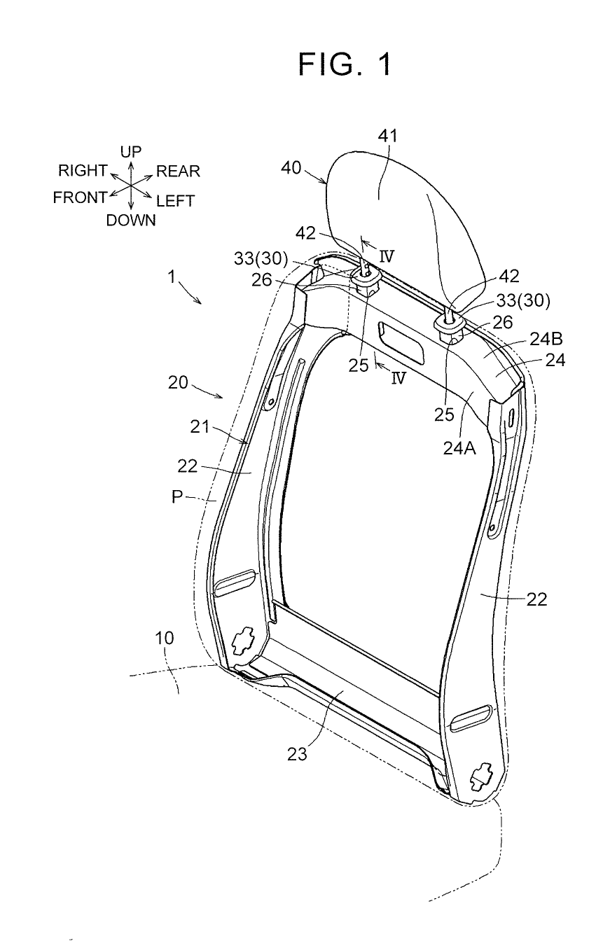

FIGS. 1 to 4 are views showing one example embodiment of the invention

This example embodiment illustrates an example in which the invention has been applied to a vehicle seat. In the drawings, the directions with respect to the vehicle when the vehicle seat is mounted in the vehicle are indicated by arrows. In the description below, a description related to a given direction will be based on that direction.

As shown in FIG. 1, a vehicle seat 1 includes a seat cushion 10, a seatback 20, and a headrest 40.

As shown in FIG. 1, the seatback 20 has a structure in which a back pad P that is a cushion is placed on a metal back frame 21 that is a frame member, and then covered from above by a back cover, not shown, that is a cover.

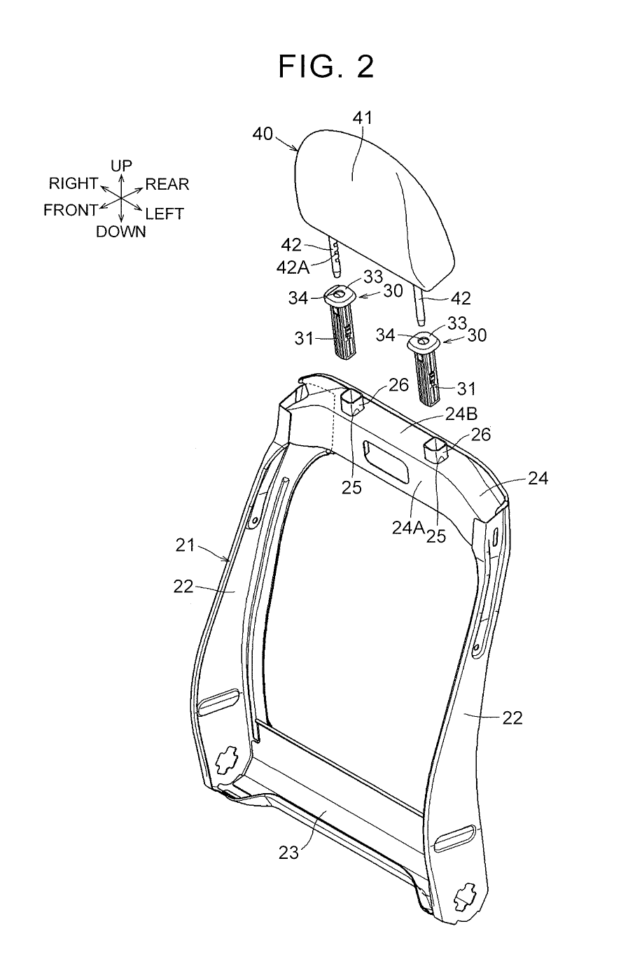

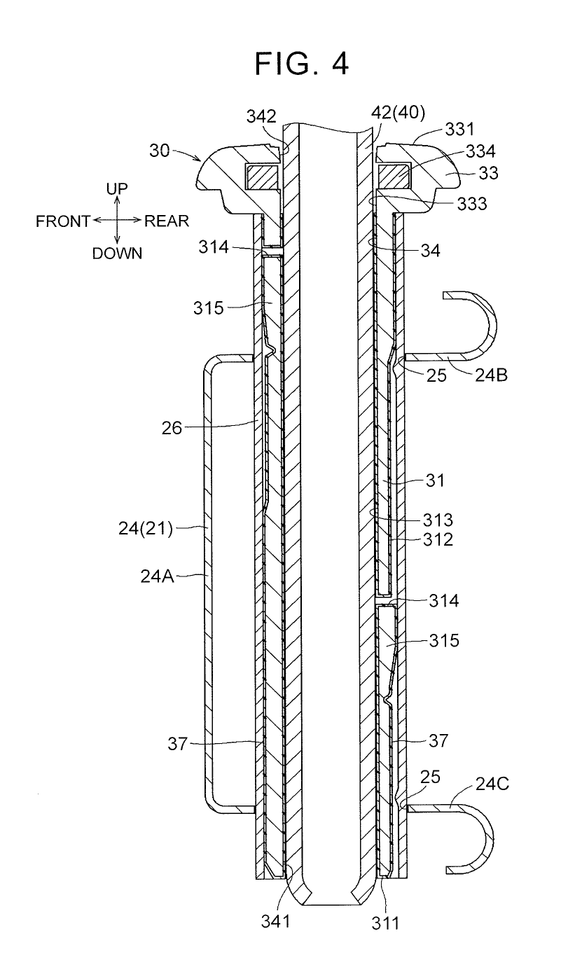

As shown in FIG. 1, the back frame 21 has a structure in which side frames 22 arranged on both the left and right sides, a lower panel 23 that connects lower end portions of the side frames 22 together, and an upper frame 24 that connects upper end portions of the side frames 22 together, are assembled in a square frame shape. As shown in FIGS. 2 and 4, the upper frame 24 includes a front wall portion 24A, an upper wall portion 24B that extends toward the rear from an upper end portion of the front wall portion 24A, and a lower wall portion 24C that extends toward the rear from a lower end portion of the front wall portion 24A. A cross-section of the upper frame 24 cut along a plane perpendicular to the length direction thereof is formed in a generally sideways U-shape that opens toward the rear. A pair of through-holes 25 positioned bilaterally symmetrical centered around the center portion in the left-right direction are formed in the upper wall portion 24B and the lower wall portion 24C of the upper frame 24. A metal support bracket 26 that has a generally square tubular shape and extends in the vertical direction is inserted and fixed in each of the through-holes 25. The support bracket 26 is fixed to the upper frame 24 by a surface of an outer cylinder portion of the support bracket 26 being welded to the upper wall portion 24B and the lower wall portion 24C of the upper frame 24 when the support bracket 26 is in a state inserted into the through-hole 25. A main body portion 31 of a headrest support 30, described later, is inserted into an inner cylinder portion of the support bracket 26.

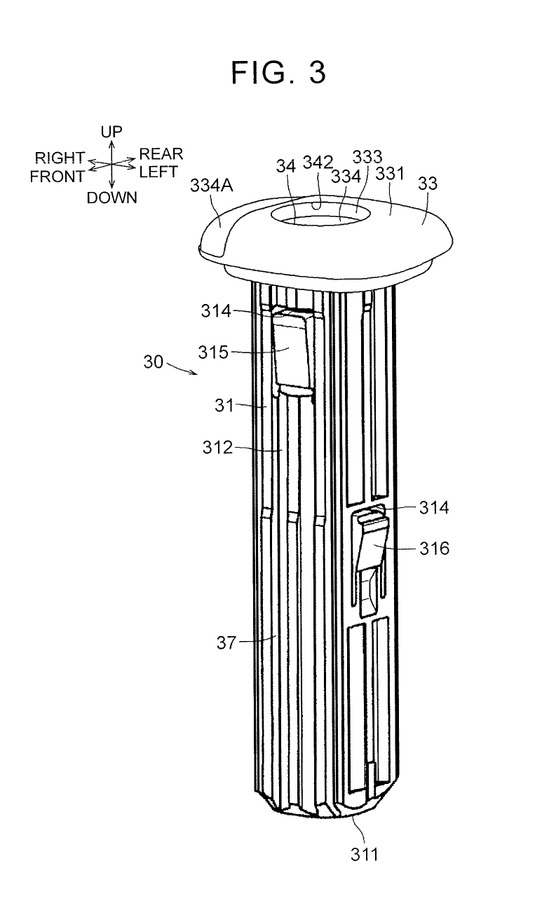

As shown in FIGS. 3 and 4, the headrest support 30 is an injection molded part made of a copolymer of polypropylene and polyethylene, and includes the generally square tubular shaped main body portion 31 that extends in the vertical direction, and a head portion 33 that extends in a flange shape in a direction perpendicular to the length direction of the main body portion 31 from an upper end portion of the main body portion 31. A generally circular cylindrical through-hole 34 of a constant diameter that extends in the vertical direction is formed in the headrest support 30. A lower opening 341 of this through-hole 34 is positioned in the surface of a lower end portion 311 of the main body portion 31, and an upper opening 342 of the through-hole 34 is positioned in the surface of an upper end portion 331 of the head portion 33.

As shown in FIGS. 3 and 4, a plurality of cutout portions 314 are formed on the main body portion 31 of the headrest support 30. These cutout portions 314 pass through from an outer cylinder portion 312 to an inner cylinder portion 313 of the main body portion 31 of the headrest support 30. Each cutout portion 314 has a generally inverted U-shape that opens downward when viewed from the front. A total of four of these cutout portions 314 are provided, one near an upper end of a front wall portion of the main body portion 31, one near a lower end of a rear wall portion of the main body portion 31, and one near the center portion in the vertical direction on both left and right wall portions. A pressing portion 315, described later, is formed on a generally inverted U-shaped inside portion of the cutout portion 314 provided on the front wall portion of the main body portion 31 and the cutout portion 314 provided on the rear wall portion of the main body portion 31. Further, an engaging portion 316, described later, is formed on the generally inverted U-shaped inside portion of the cutout portions 314 provided on both the left and right wall portions of the main body portion 31. The front-rear or left-right dimension of the portion of the outer cylinder portion 312 of the main body portion 31 other than the pressing portions 315 and the engaging portions 316 is a dimension that is slightly smaller than the front-rear or left-right dimension of the inner cylinder portion of the support bracket 26.

As shown in FIGS. 3 and 4, the pressing portion 315 provided on the front wall portion of the main body portion 31 protrudes forward from the other portion of the front wall portion, and the pressing portion 315 provided on the rear wall portion protrudes rearward from the other portion of the rear wall portion. Also, when the main body portion 31 is in a state inserted into the inner cylinder portion of the support bracket 26, the pressing portion 315 provided on the front wall portion of the main body portion 31 and the pressing portion 315 provided on the rear wall portion of the main body portion 31 bend in directions toward each other, and push against the surface of the inner cylinder portion of the support bracket 26 with elastic restoring force. As a result, the main body portion 31 is held tightly to the support bracket 26. As shown in FIG. 4, when a stay 42 of the headrest 40, which will be described later, is in a state inserted into the headrest support 30 that is inserted into the inner cylinder portion of the support bracket 26, a rear-side surface of the pressing portion 315 provided on the front wall portion of the main body portion 31, and a front-side surface of the pressing portion 315 provided on the rear wall portion, are both flush with the surface of the other portion of the inner cylinder portion 313 of the main body portion 31.

As shown in FIG. 3, the engaging portion 316 protrudes farther toward the outside in the left-right direction than the other portion of both the left and right wall portions of the main body portion 31. Also, when the main body portion 31 is in a state inserted into the inner cylinder portion of the support bracket 26, the engaging portion 316 engages with an engageable portion, not shown, formed on the support bracket 26. As a result, the main body portion 31 is held so that it will not come up out of the support bracket 26.

As shown in FIG. 4, the main body portion 31 of the headrest support 30 is covered by a PTFE resin coating 37 that has polytetrafluoroethylene (hereinafter, referred to as “PTFE”) as its main component. More specifically, the surface of the lower end portion 311, the surface of the outer cylinder portion 312, and the surface of the inner cylinder portion 313 of the main body portion 31, and the surface of a wall portion that connects the outer cylinder portion 312 to the inner cylinder portion 313 at the cutout portion 314, are covered by the PTFE resin coating 37. The PTFE resin coating 37 is a resin coating that has a lower friction of coefficient with respect to the surface of the inner cylinder portion of the support bracket 26, and lower friction of coefficient with respect to the outer surface of the stay 42 of the headrest 40, described later, than the surface of the molded part made of a copolymer of polypropylene and polyethylene. The method used to form the PTFE resin coating 37 involves first dipping the headrest support 30 in a state with the lower end portion 311 of the main body portion 31 facing down, from above into a fluorine resin solution that includes PTFE resin as its main component. Then, once the headrest support 30 has been dipped up to a boundary portion between the main body portion 31 and the head portion 33, the headrest support 30 is then raised up out of the fluorine resin solution, after which the solvent of the adhered fluorine resin solution is evaporated by natural drying, thereby forming a coating. As a result, not only the surface of the inner cylinder portion 313, but also the surface of the outer cylinder portion 312, of the headrest support 30 is able to be covered by the PTFE resin coating 37 with a single dipping operation. The PTFE resin coating 37 is one example of a “resin coating” in the claims.

As shown in FIGS. 2 to 4, the head portion 33 of the headrest support 30 on the right side includes an engaging portion 334 that is able to engage with an adjusting groove 42A of the stay 42 of the headrest 40. The engaging portion 334 is provided in a state able to move in the left-right direction. During normal operation, the engaging portion 334 is urged to the right and able to engage with the adjusting groove 42A of the stay 42 that is inserted into the headrest support 30, but when an operating portion 334A is pushed to the left, the engaging portion 334 moves to the left against the urging force, thereby disengaging from the adjusting groove 42A. That is, the engaging portion 334 moves in and out of an inner cylinder portion 333 of the head portion 33, and is therefore able to restrict and allow vertical movement of the stay 42 that is inserted into the headrest support 30. The surface of the inner cylinder portion 333 of the head portion 33 is exposed without being covered by the PTFE resin coating 37. The inner cylinder portion 333 of the head portion 33 is one example of the “upper end portion of the inner cylinder portion of the headrest support” in the claims.

As shown in FIGS. 1, 2, and 4, the headrest 40 has structure in which the metal stay 42 protrudes downward at two locations, one on the left side and one on the right side, from a lower portion of a headrest main body 41. The stay 42 has a generally cylindrical shape that extends in the vertical direction, and a diameter dimension thereof is a dimension that is slightly smaller than the dimension diameter of the through-hole 34 in the headrest support 30. A plurality of the adjusting grooves 42A that extend in the front-rear direction are formed lined up in the vertical direction on the left side of the stay 42 that is on the right side. When the stay 42 is in a state inserted into the headrest support 30, the stay 42 is able to be supported at a desired height position by the engaging portion 334 engaging with the adjusting groove 42A.

The method of assembling the headrest support 30 and the headrest 40 will now be described with reference to FIGS. 2 to 4. First, the support bracket 26 is inserted into the through-hole 25 of the upper frame 24 of the back frame 21, and the outer cylinder portion of the support bracket 26 is welded to the upper wall portion 24B and the lower wall portion 24C of the upper frame 24. Next, the main body portion 31 of the headrest support 30 is inserted from above into the inner cylinder portion of the support bracket 26.

At this time, the pressing portion 315 and the engaging portion 316 of the main body portion 31 abut against the surface of the inner cylinder portion of the support bracket 26 and bend toward the inside of the main body portion 31. In this state, when the headrest support 30 is inserted further downward such that the head portion 33 of the headrest support 30 abuts against the upper end portion of the support bracket 26, the engaging.

portion 316 returns to its original state by elastic restoring force, and engages with the engageable portion, not shown, of the support bracket 26. Moreover, after this, the stay 42 of the headrest 40 is inserted into the upper opening 342 of the through-hole 34 of the headrest support 30, and is supported in a state able to move in the vertical direction.

The example embodiment structured in this way displays the following operational advantages. The surface of the inner cylinder portion 313 of the headrest support 30 is not covered by the PTFE resin coating 37, so when the stay 42 is moved in the vertical direction with respect to the headrest support 30, the sliding resistance generated between the surface of the inner cylinder portion 313 of the headrest support 30 and the outer surface of the stay 42 is reduced, which makes the operational feeling lighter. Also, the PTFE resin coating 37 covers the surface of the inner cylinder portion 313 of the headrest support 30, so even if the stay 42 is moved upward with respect to the headrest support 30, the PTFE resin coating 37 will not be exposed outside the vehicle seat 1. Therefore, the PTFE resin coating 37 will not easily be scraped, and even if it does get scraped, the scraped portion will not appear outside the vehicle seat 1, so the appearance of the vehicle seat 1 is able to be inhibited from being damaged. Also, the surface of the outer cylinder portion 312 of the headrest support 30 is covered by the PTFE resin coating 37, so when the headrest support 30 is fitted into the inner cylinder portion of the support bracket 26, sliding resistance generated between the surface of the outer cylinder portion 312 of the headrest support 30 and the surface of the inner cylinder portion of the support bracket 26 is able to be reduced. Therefore, workability with respect to the assembly work of the headrest support 30 is able to be improved. Also, the inner cylinder portion 333 of the head portion 33 provided with the engaging portion 334 is not covered by the PTFE resin coating 37, so the PTFE resin coating 37 tends not to be affected by the in and out movement of the engaging portion 334.

Heretofore, a specific example embodiment has been described, but the invention is not limited to the appearance and structure described therein. To the contrary, various modifications, additions, and omissions are also possible within the scope of the invention.

For example, this example embodiment illustrates a structure in which the PTFE resin coating 37 that has PTFE resin as its main component is used as the resin coating that covers the surface of the inner cylinder portion 313 and the surface of the outer cylinder portion 312 of the headrest support 30. However, the resin coating is not limited to this. Another resin coating may be used as long as the coefficient of friction with respect to the outer surface of the stay 42 is lower than that of the material of which the headrest support 30 is made. That is, the resin coating may be a resin coating that has a copolymer of PTFE resin and another resin as its main component, or a resin coating that has other resin material that does not contain PTFE resin as its main component, for example.

Also, in this example embodiment, the invention is applied to a seat of a vehicle, but it may also be applied to a seat mounted in an aircraft, a marine vessel, or a train or the like.

1. A vehicle seat comprising:
a seatback;
a headrest that has a stay; and
a headrest support that is arranged on an upper portion of the seatback so as to extend in a vertical direction, and that supports the stay in a manner that allows the stay to move in the vertical direction with an outer surface of the stay in sliding contact with a surface of an inner cylinder portion of the headrest support, the surface of the inner cylinder portion being covered by a resin coating that has a lower coefficient of friction with respect to the outer surface of the stay than material of which the headrest support is made.

2. The vehicle seat according to claim 1, wherein:
the headrest support is fixed to the seatback by being fitted into the inner cylinder portion of a vertically extending cylindrical support bracket that is attached to a back frame of the seatback; and
a surface of an outer cylinder portion of the headrest support is covered by the resin coating.

3. The vehicle seat according to claim 1, wherein:
the stay is configured such that movement thereof in the vertical direction is restricted when an engaging portion provided in a manner able to move in and out on an upper end portion of the inner cylinder portion of the headrest support engages with an adjusting groove formed on the stay, and movement thereof in the vertical direction is allowed when the engaging portion disengages from the adjusting groove; and
a surface of the upper end portion of the inner cylinder portion of the headrest support is not covered by the resin coating.

4. The vehicle seat according to claim 2, wherein:
the stay is configured such that movement thereof in the vertical direction is restricted when an engaging portion provided in a manner able to move in and out on an upper end portion of the inner cylinder portion of the headrest support engages with an adjusting groove formed on the stay, and movement thereof in the vertical direction is allowed when the engaging portion disengages from the adjusting groove; and
a surface of the upper end portion of the inner cylinder portion of the headrest support is not covered by the resin coating.
